(19) United States
(12) Patent Application Publication
(10) Pub. No.: US 2004/0196465 A1
(43) Pub. Date: Oct. 7, 2004

(54) Using a change in one or more properties of light in one or more microspheres for sensing chemicals such as explosives and poison gases

(76) Inventors: Stephen Arnold, New York, NY (US); Iwao Teraoka, Rye, NY (US); Yoshiyuki Okamoto, Fort Lee, NJ (US); Frank Vollmer, New York, NY (US)

Correspondence Address: STRAUB & POKOTYLO, 620 TINTON AVENUE, BLDG. B, 2ND FLOOR, TINTON FALLS, NJ, 07724, US

(21) Appl. No.: 10/735,247

(22) Filed: Dec. 12, 2003

Related U.S. Application Data
(60) Provisional application No. 60/432,764, filed on Dec. 12, 2002.

(51) Int. Cl. G01N 21/00

(52) U.S. Cl. 356/432

(57) ABSTRACT

Detecting and/or measuring a chemical substance, such as explosives or poison gases, using a change in a property of light passing through a microsphere of a sensor. Since the microsphere has a large quality factor, the sensor is extremely sensitive. The sensor includes the microsphere coupled with at least one optical fiber. The surface of the microsphere includes receptors complementary to the chemical substance.

### § 0. RELATED APPLICATIONS

This application claims benefit to U.S. Provisional Application Serial No. 60/432,764, titled “USING MICROSPHERE SENSORS FOR SPECTROSCOPY AND SENSING CHEMICALS”, filed on Dec. 12, 2002, and listing Stephen Arnold, Iwao Teraoka, Frank Vollmer and Yoshiyuki Okamato as the inventors. That application is expressly incorporated herein by reference. The scope of the present invention is not limited to any requirements of the specific embodiments in that application.

### § 1. BACKGROUND

§ 1.1 Field of the Invention

The present invention concerns detecting the presence of, and/or measuring the amount or concentration of substances, such as chemical substances for example. More specifically, the present invention concerns detecting and/or measuring a chemical substance, such as explosives or poison gases, using a resonance shift of photons orbiting within a microsphere, absorption of photons orbiting within a microsphere, or a change in the transmission spectra of light passing through a fiber coupled with a microsphere.

§ 1.2 Related Art

§ 1.2.1 The Need to Detect Chemicals

In light of recent concerns about terrorism, detection systems for chemicals such as explosives and poison gases are needed. Such detection systems should be able to detect low-levels of the substance of concern, have high specificity to avoid false positive readings, and provide a fast response. Moreover, such detection systems should preferably be portable if applications in the field are necessary, support remote sensing, and be low cost.

Various techniques of sensing chemicals (including those of biological origin) have been developed and field-tested. Sensor systems that use ligands to detect fluorescence spectrum change upon complexation with a target chemical have been studied as a sensitive, compact, low-cost sensor. (See, e.g., the articles, A. L. Jenkins, O. M. Uy,; G. M Murray, “Polymer-Based Lanthanide Luminescent Sensor for Detection of the Hydrolysis Product of the Nerve Agent Soman in Water,” Anal. Chem., 71, 373, (1999); and X. Wang, S.-H. Lee, C. Drew, K. J. Senecal, J. Kumar, L. A. Samuelson, “Fluorescent Electronspun Polymer Films for the Detection of Explosives,” Polym. Preprint, 43, 130 (2002); and Landmine Detectors and Advanced Sensors at the Website www.nomadics.com, each incorporated herein by reference.) For instance, trinitrotoluene (TNT) complexes with polyaromatic compounds to quench the fluorescence emission spectrum and shift UV-absorption spectrum, thereby allowing detection of a trace amount of TNT vapor that will be present above the ground where landmines are buried. (See, e.g. the Wang et al article and the nomadics Website.) To detect Soman, a nerve agent, in underground water, a fluorescence spectrum change upon adsorption of its hydrolysis product onto lanthanide metal-organic complex was used. (See, e.g., the Jenkins et al article.) In the latter, molecular imprinting technology by copolymerizing complexed monomers with styrene and divinylbenzene was employed. Unfortunately, however, these systems have limited sensitivity, which may preclude certain applications.

Naturally, there are many other applications for detecting chemical substances.

§ 1.2.2 Measurement Principle Using Ray Optics in Microsphere Having a Chaning Size

U.S. patent application Ser. No. 10/096,333, titled “DETECTING AND/OR MEASURING A SUBSTANCE BASED ON A RESONANCE SHIFT OF PHOTONS ORBITING WITHIN A MICROSPHERE,” filed on Mar. 12, 2002 and listing Stephen Arnold and Iwao Teraoka as inventors (referred to as “the '333 application” and incorporated herein by reference) describes using a resonance shift in one or more microspheres to detect the presence or concentration of a target substance. The techniques described in the '333 application allow detection of chemicals at ppt concentrations and, at the same time, minimize false positive readings. Operating principles of such microsphere sensors are described below.

Resonances in a geometrical optics limit are associated with the optical ray paths, such as those 110 illustrated in the cross section of a particle 100 illustrated in FIG. 1. Total internal reflection keeps the photon(s) from radiating outward. Collectively, the ray path segments 110 define a polygon.

Basically, the light circles (or orbits) the interior of the particle 100, returning in phase. This is known as a mode of the first order. For higher order modes, the photon(s) takes several orbits before its ray path closes—i.e., before the photon returns in phase.

The foregoing illustration and assumptions are appropriate for meso-optic elements (i.e., devices, comparable in size to the wavelength of light, that can confine photons) 100 having a diameter 2a that is between 10 and 100 times the wavelength of the photon. The resonances have specific polarization states.

Referring to FIG. 2, an optical fiber 200 may be evanescently coupled with a microsphere 100′. More specifically, an evanescent electromagnetic field associated with total internal reflection exists just outside the microsphere 100′, decaying exponentially as a function of distance, typically over a distance of ˜0.1 μm. Further, internal reflection on a curved surface induces a small amount of radiation leakage in the far field. The higher the order of the mode, the greater the leakage. For example, the energy loss in one oscillation within slightly spheroidal fused silica microspheres (2a>˜50 μm) has been measured to be smaller than 2 billionths of the energy contained, yielding a quality factor Q>˜10⁸. Stated in another way, the linewidth of the associated resonance (δf) in the spectrum is 10 billionth of the frequency (δf=f/Q). Referring to FIG. 3, the resonance modes can be detected as transmission dips 300 in the evanescently coupled optical fiber 200.

As illustrated in FIG. 4, if the size (or shape, or refractive index) of the particle 100/100′ changes, the resonances shift in frequency. For example, in the case of a sphere, as its radius increases, the resonance occurs at a longer wavelength. This shift can be expressed as:

$$\frac{Δ a}{a} = \frac{Δ λ}{λ} \qquad ( 1 )$$

This relationship may be derived as follows.

When considering size sensitivity, recognize that the angular momentum L of the photon in a given mode is quantized. That is

$$L = ( \frac{h}{2 π} ) \sqrt{l ( l + 1 )} ,$$

where 1 is an integer and h is Plank's constant. The angular momentum in the geometry of FIG. 1 is equal to its linear momentum (p) times the distance of the closest approach from the sphere center (a cos(π/q)), where q is the number of reflections in the orbit. The linear momentum p of the photon is its energy (hf) divided by the speed of light in the medium. That is, p=hfn/c, where f is the frequency, n is the refractive index of the sphere, and c is the speed of light in vacuum. Consequently, the angular momentum may be expressed as:

$$L = \frac{hfna}{c} cos \frac{π}{q} = \frac{hna}{λ} cos \frac{π}{q} \qquad ( 2 )$$

where λ is the wavelength in vacuum.

Since the resonance mode has a constant angular momentum, equation (2) can be used to estimate the effect that various perturbations have on the resonance wavelength. For example, to reiterate, as was illustrated in FIG. 4, if the size (or shape, or refractive index) of the particle 100/100′ changes, the resonances shift in frequency. In the case of a sphere, as its radius increases, the resonance occurs at a longer wavelength. This shift can be expressed as:

$$\frac{Δ a}{a} = \frac{Δ λ}{λ} \qquad ( 1 )$$

The sensitivity of this measurement technique can be estimated as follows. If it is assumed that the linewidth (δλ≅10⁻⁸λ), then the smallest “measurable” size change is |Δa|ₘᵢₙ=10⁻⁸a. Assuming a sphere radius (a) on the order of 10 μm, |Δa|ₘᵢₙ=10⁻¹³m. This is much smaller than the size of an atom.

Unfortunately, the resonance of photon(s) orbiting within a microsphere is fairly sensitive to changes in temperature. To estimate the resonance shift due to temperature change, both the radius and refractive index (n) of the microsphere are permitted to vary. Based on equation (2), the fractional shift in wavelength may be expressed as:

$$\frac{Δ λ}{λ} = \frac{Δ a}{a} + \frac{Δ n}{n} \qquad ( 3 )$$

In most amorphous optical materials, both the size and the refractive index will change approximately linearly with temperature at near room temperature. Thus, there is a need for improving the foregoing technique of detecting and/or measuring a substance based on a resonance shift of photons orbiting within a microsphere, by making it insensitive or less sensitive to changes in temperature. Indeed, it would be useful to make the foregoing technique insensitive or less sensitive to changes other than changes in the amount or concentration of the substance being detected or measured.

One challenge to using the foregoing techniques to sense chemicals such as explosives and poison gases is determining receptors and attaching them to the microsphere.

### § 2. SUMMARY OF THE INVENTION

The present invention may provide a detection and/or measurement technique using a change in one or more properties of photons orbiting within a microsphere. The present invention may do so by applying a light source to a sensor including a microsphere coupled with an optical carrier, detecting light at the other end of the optical carrier, and determining adsorption of a material onto the microsphere based on the detected light.

The present invention may also provide improved techniques for attaching receptors for sensing chemicals such as explosives and poison gases, to a microsphere.

### § 30 BRIEF DESCRIPTION OF THE DRAWINGS

FIG. 1 is a cross sectional view of internal reflections in a microsphere.

FIG. 2 illustrates the evanescent coupling of an optical fiber and a microsphere.

FIG. 3 illustrates transmission dips detected in light passing through an optical fiber evanescently coupled with a microsphere, such as that illustrated in FIG. 2.

FIG. 4 illustrates the shift in resonance of photon(s) orbiting within a sphere as the size of the sphere changes.

FIG. 5 illustrates operations that may be performed by a system for detecting and/or measuring a substance based on a resonance shift of photons orbiting within a microsphere.

FIG. 6 illustrates operations that may be performed when fabricating a sensor head for use in a system, such as that illustrated in FIG. 5, for detecting and/or measuring a substance based on a resonance shift of photons orbiting within a microsphere.

FIG. 7 illustrates an exemplary system for detecting and/or measuring a substance based on a resonance shift of photons orbiting within a microsphere.

FIG. 8 illustrates a single-sphere sensor head that may be used in a system for detecting and/or measuring a substance based on a resonance shift of photons orbiting within a microsphere.

FIG. 9 illustrates an exemplary single-sphere sensor.

FIG. 10 illustrates a multiple-sphere sensor head that may be used in a system for detecting and/or measuring a substance based on a resonance shift of photons orbiting within a microsphere.

FIG. 11 illustrates a multiple-sphere sensor in which one of three receptors is modified with a receptor A to attract a ligand A′.

FIGS. 12A and 12B illustrate the frequency spectra of light detected through the sensors of FIGS. 11 and 13, respectively.

FIG. 13 illustrates the multiple-sphere sensor head of FIG. 11 placed into a solution including substance A′.

FIG. 14 is a flow diagram of an exemplary measurement method for use with a single-sphere sensing head.

FIG. 15 is a flow diagram of an exemplary measurement method for use with a multiple-sphere sensing head.

FIG. 16 is a cross-sectional end view of a microsphere coupled with an optical fiber.

FIGS. 17A and 17B illustrate symmetric and asymmetric contact, respectively, between a microsphere and an optical fiber.

FIG. 18 is a resonance frequency spectrum of detected light that has passed through a sensing head.

FIG. 19 illustrates an experimental system used to observe the resonance frequencies of a microsphere connected with an optical fiber.

FIG. 20 is a cross-sectional end view of a microsphere coupled onto a cylindrically eroded fiber.

FIGS. 21A and 21B illustrate a silica fiber with cladding and cylindrically eroded cladding, respectively.

FIG. 22 illustrates a change in fiber transmission spectrum due to absorption.

FIG. 23 illustrates a transmission spectrum through a fiber with multiple spheres.

FIG. 24 illustrates an NIR absorption spectrum of DNT.

FIGS. 25A-25AD illustrates operating principles of a fluorescence and absorption spectrum sensor.

FIG. 26 illustrates a microsphere sensor box consistent with the present invention.

FIG. 27 illustrates a modification of a silica surface in a manner consistent with the present invention.

FIG. 28 illustrates a modification of a PMMA surface used for coupling a fiber and a microsphere in a manner consistent with the present invention.

FIG. 29 illustrates a modification of a PS surface used for coupling a fiber and a microsphere in a manner consistent with the present invention.

FIG. 30 illustrates covalent bonding of a fiber and sphere in a manner consistent with the present invention.

FIG. 31 illustrates attaching pyrenes, useful as a TNT receptor, onto a silica surface in a manner consistent with the present invention.

FIG. 32 illustrates attaching pyrenes, useful as a TNT receptor, onto an amine-modified silica surface in a manner consistent with the present invention.

FIG. 33 illustrates attaching Europium chelate, useful as a Soman receptor, onto a silica surface in a manner consistent with the present invention.

FIG. 34 is a block diagram of a fluorescence spectrum measurement system that is consistent with the present invention.

FIG. 35 is a block diagram of an absorption spectrum measurement system that is consistent with the present invention.

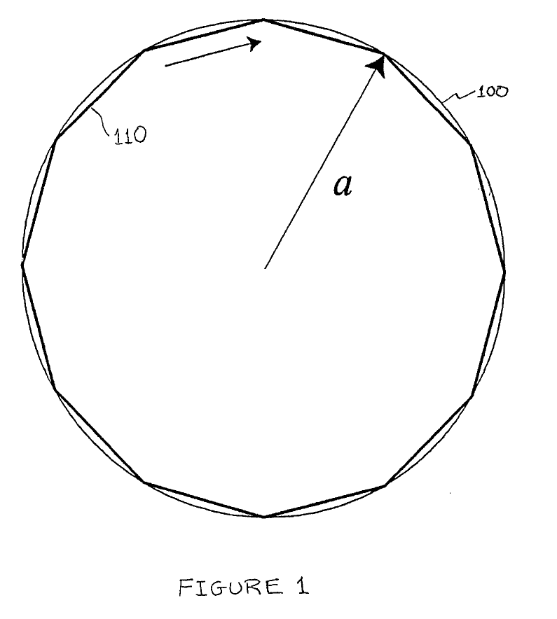

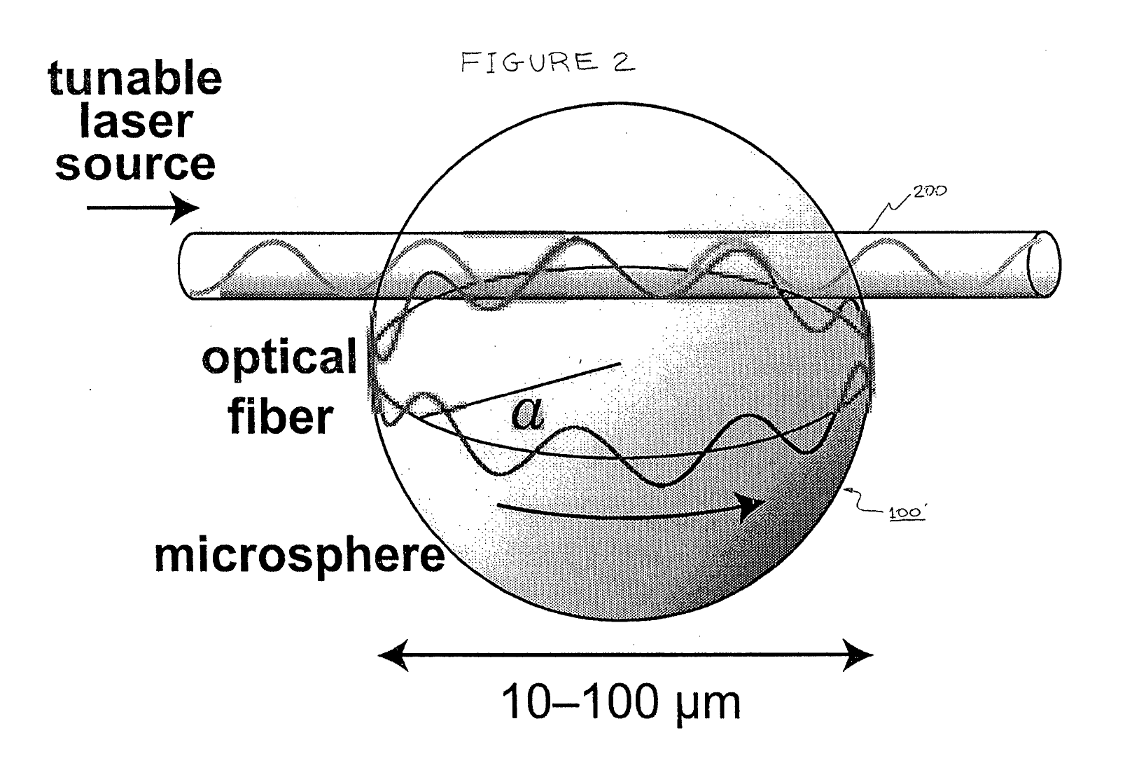

### § 4. DETAILED DESCRIPTION OF THE INVENTION

The present invention involves novel methods and/or apparatus for detecting and/or measuring a chemical substance such as an explosive or a poison gas. The following description is presented to enable one skilled in the art to make and use the invention, and is provided in the context of particular embodiments and methods. Various modifications to the disclosed embodiments and methods will be apparent to those skilled in the art, and the general principles set forth below may be applied to other embodiments, methods and applications. Thus, the present invention is not intended to be limited to the embodiments and methods shown and the inventors regard their invention as the following disclosed methods, apparatus and materials and any other patentable subject matter to the extent that they are patentable.

§ 4.1 Exemplary Applications

The present invention may be used to detect and/or measure chemical substances, such as explosives or poison gases for example. The particular substance to be detected and/or measured may affect the design (e.g., size, material, etc.) of the microsphere, as well as the choice of receptors. Exemplary sensors, used to detect explosives such as TNT and poison gases such as Soman, are described in § 4.4.2 below.

§ 4.2 Functions that may be Performed

The present invention may function to detect and/or measure a chemical substance using a change in one or more properties of photons orbiting within a microsphere. The present invention may also function to attach receptors for an explosive such as TNT, or a poison gas such as Soman, to a microsphere.

§ 4.3 Exemplary Operations

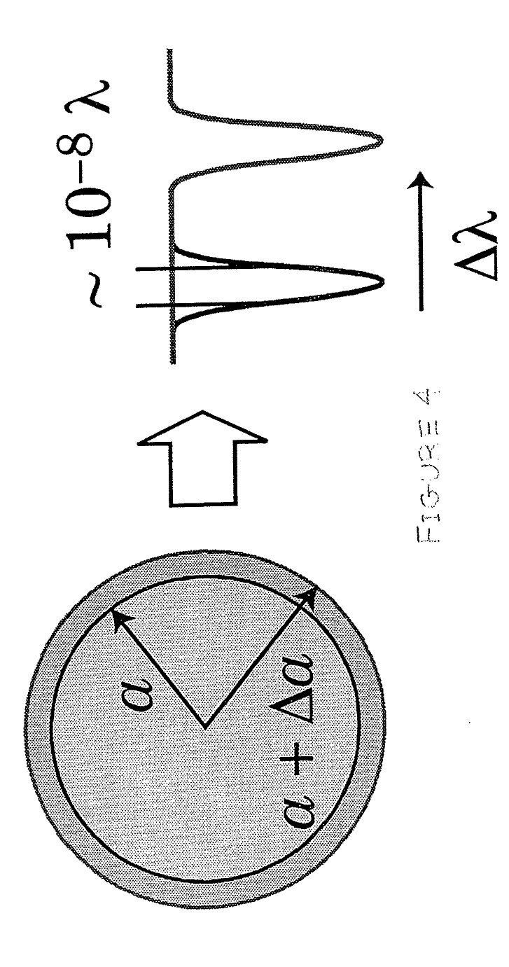

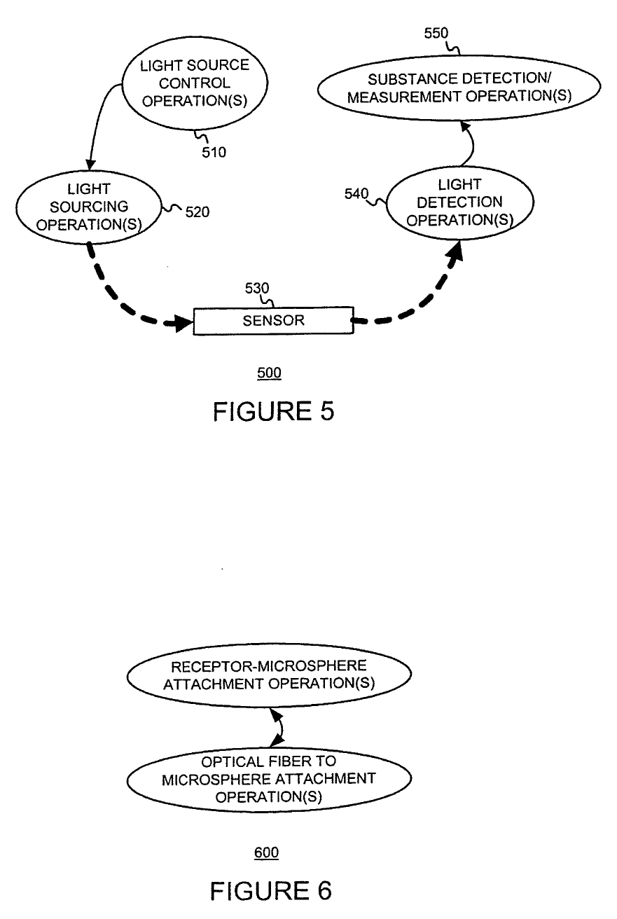

FIG. 5 is a bubble chart illustrating operations that may be performed in detecting and/or measuring a substance in accordance with the present invention. A light sourcing operation 520 may emit a light, under the control of a light source control operation 510, into (or through) a sensor 530. A detection operation 540 may detect light from the sensor 530. Certain detected properties of the light may then be provided to detection and/or measurement operation(s) 550. Exemplary methods and apparatus that may be used to effect these various operations are described in § 4.4.1 below.

Certain aspects of the present invention concern the fabrication of a sensor to be used in a system such as that illustrated in FIG. 5. FIG. 6 is a bubble chart illustrating operations that may be performing in fabricating a sensor in accordance with the present invention. Basically, the fabrication of a sensor in a manner consistent with the present invention may include two operations—attaching 610 the receptor(s) to the microsphere(s), and coupling 620 the microsphere(s) to the optical fiber. Exemplary methods, apparatus and materials that may be used to effect these various operations are described in § 4.4.2 below.

§ 4.4 Exemplary Methods and Apparatus for Performing the Exemplary Operations

Exemplary methods and apparatus that may be used to perform operations related to detecting and/or measuring a substance are described in § 4.4.1 below. Then, exemplary methods, apparatus and compositions of matter that may be used to perform operations related to fabricating sensors are described in § 4.4.2 below.

§ 4.4.1 Exemplary Methods and Apparatus for Performing Operations Related to Detecting and/or Measuring Substances

In the following, exemplary apparatus for detecting and/or measuring substances are described in § 4.4.1.1, while exemplary methods are described in § 4.4.1.2.

§ 4.4.1.1 Exemplary Apparatus for Detecting and/or Measuring Substances

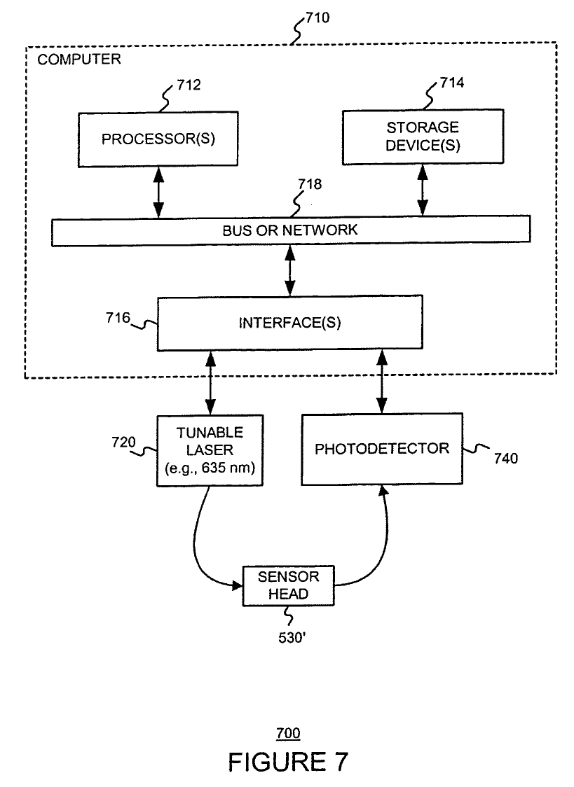

The present invention may use (a) adsorption measurement, (b) fluorescence spectrum measurement, or (c) adsorption spectrum measurement. Systems for performing these types of measurements are described below with reference to FIGS. 7, 34 and 35.

FIG. 7 is a block diagram of an adsorption measurement system 700 that may be used to perform the operations of FIG. 5. A computing device, such as a personal computer for example, may function to (a) control a tunable laser 720 (e.g., a tunable DFB laser driven by a current source (ILX Lightwave) with temperature control), and (b) to determine the existence or amount of a substance based on the output of a photodetector 740 (e.g., from ThorLabs). The sensor apparatus 530′ may be a sensor head or a sensor box.

An exemplary tunable laser 720 is the model 2010A, available from Newport Corporation of Irvine, Calif., which permits scanning the CW laser with an external cavity. The tuning range of the exemplary laser 720 may be ±4 nm with the center wavelength at 635 nm. The linewidth of the exemplary laser 720 may be less than 1 kHz, with a resolution on the order of 10⁻¹¹. An exemplary detector 740 is the model PDA55 broadband photodiode detector available from Thorlabs, Inc. of Newton, N.J. The output of the detector may be digitized by an analog-to-digital converter, such as the 16-bit, 200 kHz model PCI-6034E from National Instruments Corporation of Austin, Tex., in the personal computer.

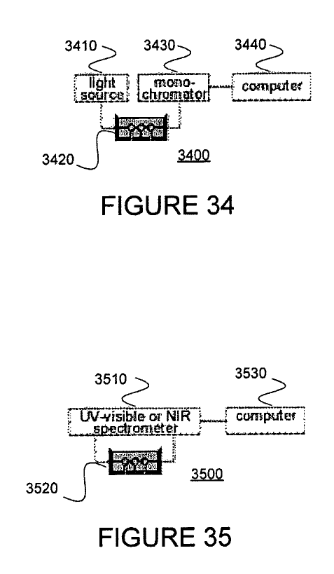

FIG. 34 is a block diagram of a fluorescence spectrum measurement system 3400 that may be used to perform the operations of FIG. 5. The system 3400 may include a short-wavelength light source 3410, a sensor box (or some other sensor apparatus) 3420, a monochromator (e.g., from ThorLabs) 3430, and a computer 3440 (such as computer 710 of FIG. 7).

FIG. 35 is a block diagram of an absorption spectrum measurement system 3500 that may be used to perform the operations of FIG. 5. The system 3500 may include an NIR spectrometer (e.g., from Ocean Optics) 3510, a sensor box (or some other sensor apparatus) 3520, and a computer 3530 (such as computer 710 of FIG. 7). Mid-IR spectrum may also be obtained by using chalcogenide fibers through an attachment in an existing FT-IR spectrometer.

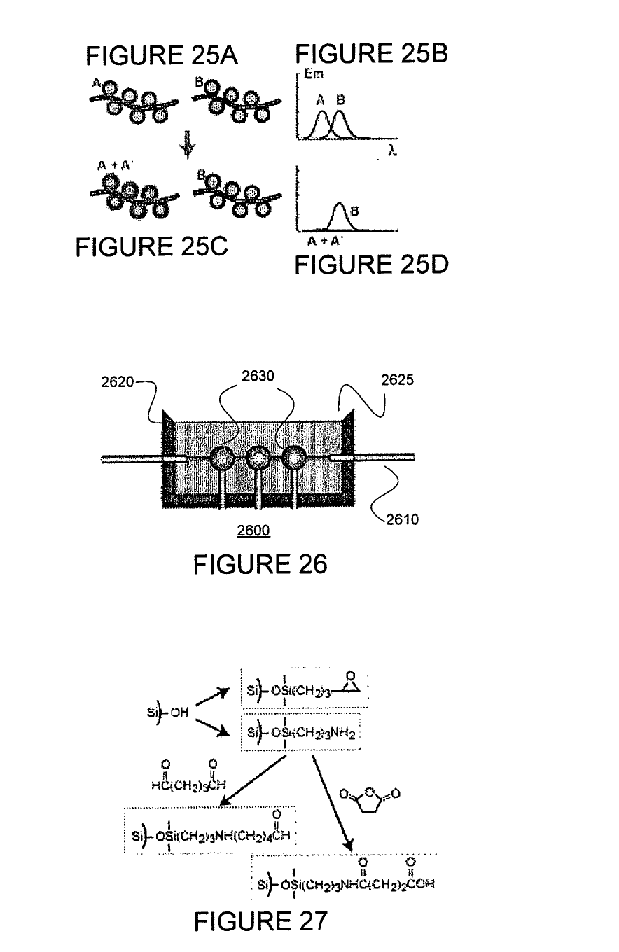

Note that a multiple-sphere sensing head can be used differently in adsorption measurement than in spectrometry. For spectrometry, multiple spheres may be used to smooth the emission and absorption spectra and to enhance the magnitude of each peak. Specificity may be enhanced by using multiple sensor boxes, each equipped with spheres of different surface moieties as illustrated in FIGS. 25A-25D. For the adsorption measurement, a single sensor box with multiple spheres, each with a different surface modification including non-stick surface, may be sufficient to distinguish a detection signal from a false signal.

§ 4.4.1.1.1 Exemplary Sensing Apparatus such as a Sensing Head and a Sensing Box

Although not shown, standard optical fiber connectors may be provided to facilitate the exchange of sensing apparatus 530/3420/3520, such as sensing heads or a sensor box.

A sensing head may have a number of possible configurations, two of which are described in detail below. The first sensing head configuration is referred to as a single-sphere sensing head. The second sensing head configuration is referred to as a multiple-sphere sensing head. In either case, the radius of the microsphere(s) preferably ranges from about 2 μm to about 1 mm, and more preferably is from about 10 μm to about 100 μm. A sensing box is also described.

§ 4.4.1.1.1.1 Single-Sphere Sensing Head

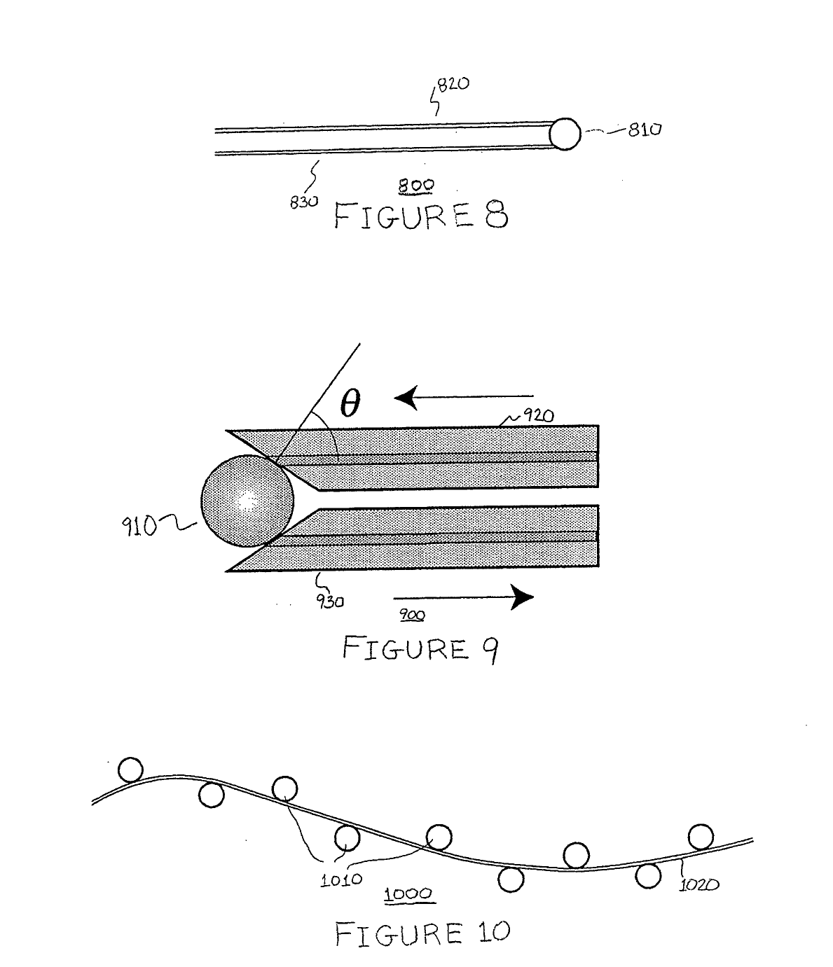

As shown in FIG. 8, an exemplary single-sphere sensing head 800 may include a microsphere 810 positioned at the end of a pair of optical fibers 820/830. One of the optical fibers 820 is optically coupled with a light source, while the other is optically coupled with a photodetector. For example, FIG. 9 is a cross-section of a possible design for a single-sphere sensing head 900 including a microsphere 900 positioned at the end of a pair of optical fibers 920/930. Light directed through optical fiber 920 toward the microsphere 910 may reach the beveled surface of the fiber at an angle θ, such as the one greater than the critical angle θ_{c}(sin θ_{c}=nₛₚₕₑᵣₑ/n_{core}, where nₛₚₕₑᵣₑ and n_{core} are the refractive indices of the sphere and the fiber core, respectively). The evanescent field just outside the optical fiber 920 couples to the evanescent field of a particular resonant mode of the microsphere 910. The other optical fiber 930 senses this evanescent field around the microsphere 910. Consequently, peaks can be observed in the outgoing optical fiber 930 at the resonant frequencies. An exemplary single-sphere sensing head having the general features as that 900 illustrated in FIG. 9 may be fabricated in the manner described in § 4.4.2 below.

§ 4.4.1.1.1.2 Multiple-Sphere Sensing Head

A multiple-sphere sensing head will now be described. First, however, the challenges that led to the multiple-sphere sensing head are introduced. Recall that the resonance characteristics of a microsphere are based on (i) the size of the microsphere, (ii) the shape of the microsphere, (iii) the refractive indices of the microsphere and the surrounding medium, and (iv) the adsorption of the microsphere. Some of these factors will be influenced by the local temperature, the stress on the microsphere, and the concentration or the presence of the substance to be measured in the surrounding medium (e.g., fluid). Recall also that the sensitivity of the resonance frequencies to changes in temperature is relatively high. Indeed, the resonance frequencies of the microsphere may be extremely susceptible to environmental disturbances. For example, a slight drift in temperature, or pressure of the surrounding medium, or a change in a solvent composition (and consequently, its refractive index) in which the microsphere is placed, may cause a large change in the resonance characteristics, perhaps exceeding the change caused by the adsorption of the substance or the presence of the substance in close proximity of the microsphere surface. A multiple-sphere sensing head will mitigate or eliminate these problems.

As shown in FIG. 10, an exemplary multiple-sphere sensing head 1000 may include at least two microspheres 1010 coupled with an optical fiber 1020. One end of the optical fiber 1020 is optically coupled with a light source, while the other end is optically coupled with a photodetector. In one embodiment, the surface of each microsphere 1010 is modified with a receptor to interact with a specific ligand, though at least one of the microspheres may 1010 remain unmodified. In such an embodiment, changes due to the environmental disturbances affect the resonance characteristics for all of the microspheres 1010 in the same way. This affect on the resonance characteristics of the microspheres 1010 can be characterized as “common-mode noise”. On the other hand, the adsorption of a specific ligand will affect only the microsphere(s) 1010 having the associated receptor. The common-mode noise can be removed from the signal using wavelength screening and spectrum interpretation. An example of this is illustrated in FIGS. 11, 12A, 12B and 13.

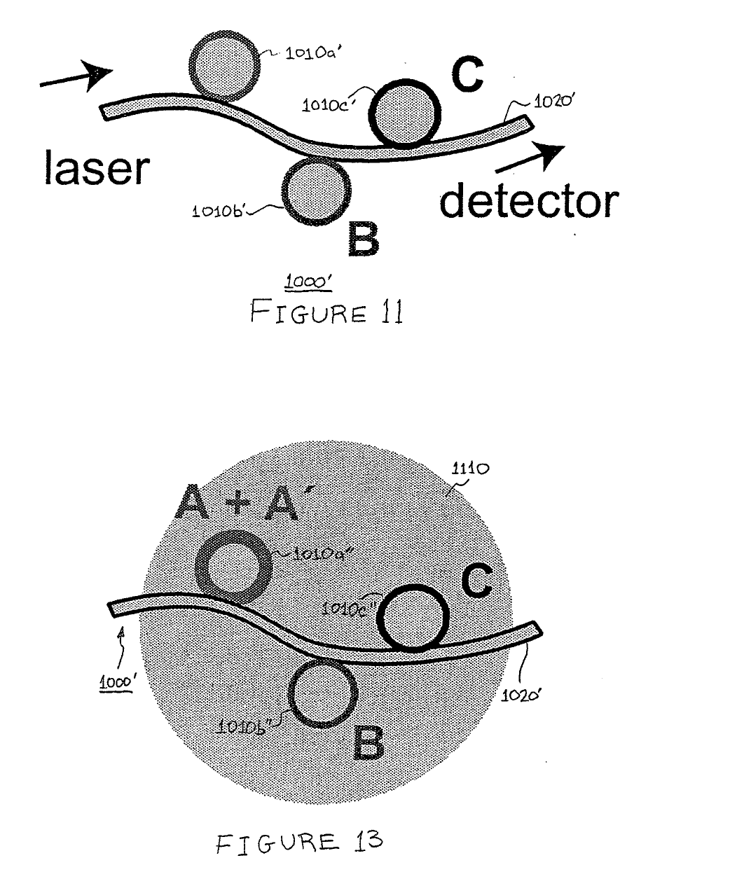

FIG. 11 illustrates a multiple-sphere sensing head 1000′ including an optical fiber 1020′ and three microspheres 1010a′, 1010b′ and 1010c′. The microsphere 1010a′ is modified with a receptor for ligand A. FIG. 12A illustrates the dips in the frequency spectrum associated with a resonance frequency associated with each of the microspheres 1010a′, 1100b′ and 1010c′. Notice that the distinct dips can be used to distinguish the microspheres. FIG. 13 illustrates the multiple-sphere sensing head 1000′ immersed in a solution 1100 containing substance A. Notice from FIG. 12B that all of the frequencies of all of the dips, associated with the resonant frequencies of the microspheres 1010a″, 1010b′ and 1010c′ have all shifted to some extent due to common-mode noise, but the frequency of the dip associated with the resonant frequency of microsphere 1010a″ will have also shifted (in the same or opposite direction as the shift due to the common-mode noise) due to the change in the size of microsphere 1010a″ resulting from the adsorption of substance A. As can be seen in FIGS. 12A and 12B, the shift due to adsorption can be distinguished from that due to the noise.

§ 4.4.1.1.1.3 Sensor Box

As shown in FIG. 26, in a sensor box 2600, a transmission line 2610 may run from one side of the box 2620 to the other. Many spheres 2630 can be placed near the fiber for coupling. As shown, one side 2625 of the housing 2620 may be open to the ambient environment.

§ 4.4.1.2 Exemplary Methods for Detecting and/or Measuring Substances

§ 4.4.1.2.1 Adsorption

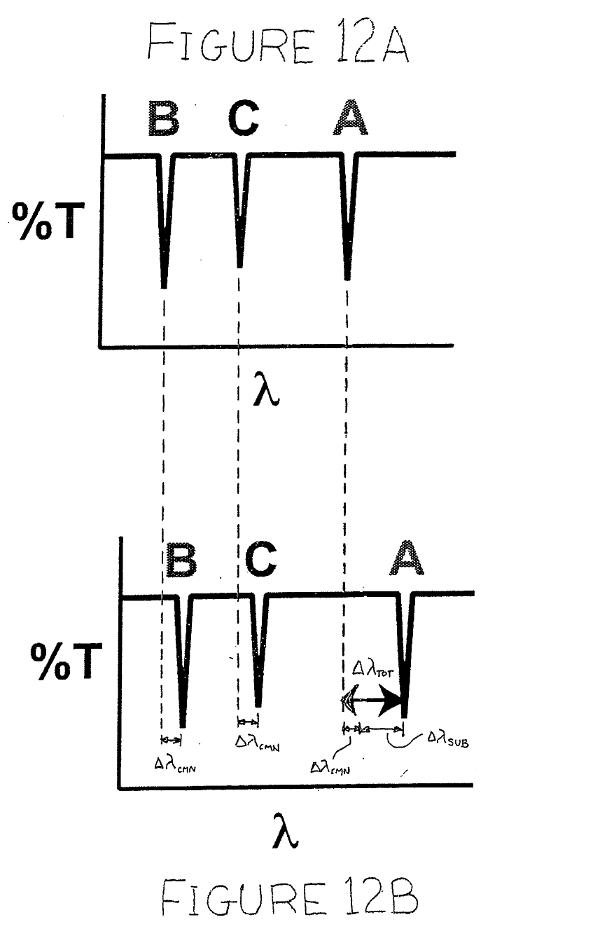

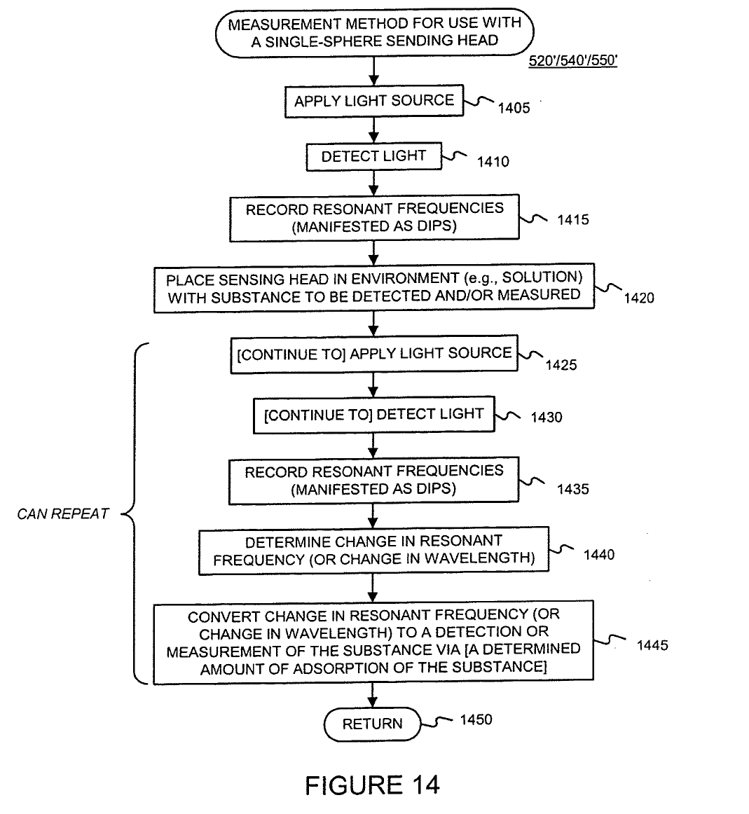

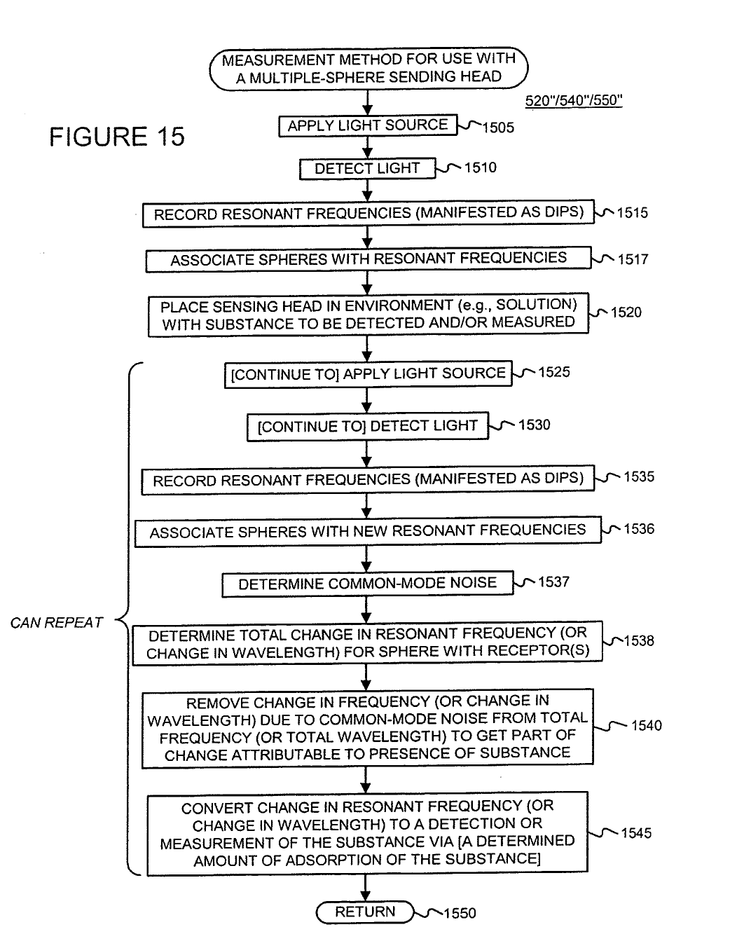

Exemplary methods for detecting and/or measuring substances using a single-sphere sensing head and a multiple-sphere sensing head, are described with reference to FIGS. 14 and 15, respectively.

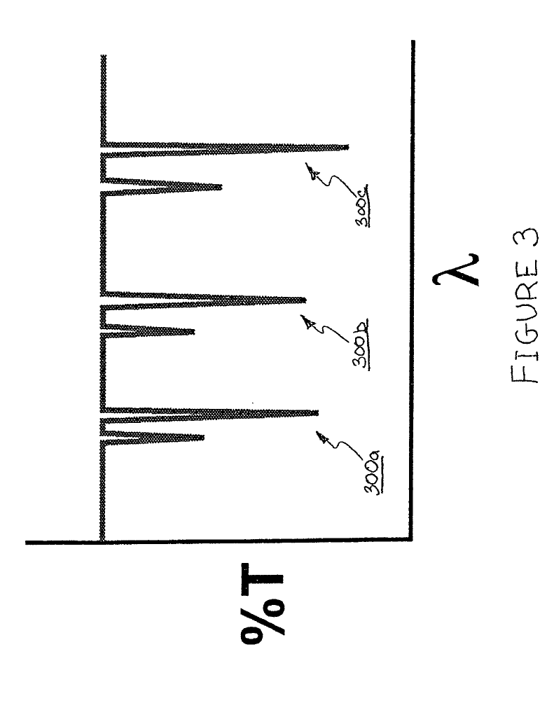

FIG. 14 is a flow diagram of an exemplary method 520′/540′/550′ that may be used to effect light sourcing operations 520, light detection operations 540, and substance detection and/or measurement operations 550 used with a single-sphere sensor head. The order in which the acts are performed is not intended to be limited by the order shown in FIG. 14. As shown in block 1405, a light source is applied. The light source may be a tunable laser, for example, and may be applied to a first fiber of single-sphere head sensor (Recall, e.g., 920 of FIG. 9.) or a first end of a fiber having an attached micro-sphere. As indicated by block 1410, light is detected. The light may be detected by a broadband, photodiode detector, for example, which may be coupled with a second fiber of a single-sphere head sensor (Recall, e.g., 930 of FIG. 9.), or with a second end of a fiber having an attached micro-sphere. The resonant frequencies, seen as dips (Recall, e.g., FIG. 3.), may be recorded, as indicated by block 1415. Then, as indicated by block 1420, the sensing head is placed in the environment (e.g., a solution) which may include the substance to be detected and/or measured. As was the case with blocks 1405 and 1410, a light source is (or continues to be) supplied and the resulting light is detected as indicated by acts 1425 and 1430, respectively. As was the case with block 1415, the resonant frequencies, seen as dips, may be recorded, as indicated by block 1435. The change in resonant frequency (or the change in the associated wavelength) is determined, as indicated in block 1440. This may simply be a matter of determining the differences between the dips before and after the sensing head is placed in the environment (e.g., solution) which may include the substance to be detected and/or measured. Finally, as indicated by block 1445, the determined change in resonant frequency (or determined change in the wavelength) is converted to a detection or measurement of the substance. As indicated by the bracket adjacent to blocks 1425 through 1445, these acts may be repeated to determine adsorption on other microspheres, for example, which may be converted to a concentration of another substance. The method may be left via RETURN node 1450.

Recall from § 4.4.1.1.3.2 above that by using a multiple-sphere sensing head, common-mode noise can be removed from the signal using wavelength screening and spectrum interpretation. That is, since the frequencies of all of the dips, associated with the resonant frequencies of the microspheres, all shift to some extent due to common-mode noise, but the frequency of the dip associated with the resonant frequency of a microsphere with receptors will also shift (in the same or opposite direction as the shift due to the common-mode noise) due to the change in the size of that microsphere resulting from the adsorption of a substance, the shift due to adsorption can be distinguished from that due to the noise.

FIG. 15 is a flow diagram of an exemplary method 520″/540″/550″ that may be used to effect light sourcing operations 520, light detection operations 540, and substance detection and/or measurement operations 550 used with a multiple-sphere sensor head. The order in which the acts are performed is not intended to be limited by the order shown in FIG. 15. As shown in block 1505, a light source is applied. The light source may be a tunable laser, for example, and may be applied to a first end of a fiber having attached micro-spheres (Recall, e.g., FIG. 11.). As indicated by block 1510, light is detected. The light may be detected by a broadband photodiode detector, for example, which may be coupled with a second end of the fiber having the attached micro-spheres. The resonant frequencies, seen as dips (Recall, e.g., FIG. 12A.), may be recorded, as indicated by block 1515. These resonant frequencies are associated with the various microspheres as indicated by block 1517. This may be done by monitoring a transmission spectrum through the fiber. For example, recall from equation (1) that Δλ is proportional to Δa. Resonance from two microspheres differing by 10⁻⁷a should be easily distinguishable. Given that the standard deviation in “a” for emulsion polymerization of a polystyrene microsphere is >10⁻²a, the resonance frequency of each microsphere, among ˜1000 of microspheres, should be easily distinguished from those resonance frequencies of the other microspheres. Then, as indicated by block 1520, the sensing head is placed in the environment (e.g., a solution) which may include the substance to be detected and/or measured. As was the case with blocks 1505 and 1510, a light source is (or continues to be) supplied and the resulting light is detected as indicated by acts 1525 and 1530, respectively. As was the case with block 1515, the resonant frequencies, seen as dips, may be recorded, as indicated by block 1535. As was the case with block 1517, the resonant frequencies are associated with the microspheres, as indicated by block 1536.

Common-mode noise may then be determined, as indicated by block 1537. (Recall, e.g., FIGS. 12A and 12B.) The total change in resonant frequency (or the total change in wavelength) for the microsphere(s) provided with the receptor(s) is then determined as indicated by block 1538. Then, as indicated by block 1540, the amount of change in resonant frequency (or wavelength) due to common-mode noise is removed from the total change in resonant frequency (or wavelength) to obtain the part of the change attributable to the presence of the substance being detected and/or measured. Finally, as indicated by block 1545, the part of the determined change in resonant frequency (or determined change in the wavelength) attributable to the presence of the substance is converted to a detection or measurement of the substance. As indicated by the bracket adjacent to blocks 1525 through 1545, these acts may be repeated to determine a rate of adsorption, for example, which may be converted to a concentration of the substance. The method may be left via RETURN node 1550.

§ 4.4.1.2.2 Fluorescence and Absorbtion Spectroscopy

Adsorption-induced changes in the resonance characteristics are not limited to the wavelength shift. Absorption of light by the adsorbed molecules can also be sensitively detected. In fact, broad linewidths in the transmission spectrum may be due to the first overtone modes of OH stretch in water molecules. Recall that absorption measurement exploits high-Q resonance. Q as large as 10⁸ means that a photon would travel a distance of approximately 10⁷ times its wavelength in its life time. The distance amounts to about 10 m for λ=1 μm. During its travel, the photon explores a radial distance equal to λ from the sphere surface, as its evanescent electric field extends into the surrounding medium. The travel distance is equivalent to a spectrometer cell of about 10 m in path length. This long path length comes on top of a high surface density a of adsorbed molecules on the sphere surface, which translates into the volume density of the molecules, σ/λ, in the evanescent region as large as 0.001 mol/L. An even weak molar absorptivity of 1 L/(cm·mol) can generate an absorbance of about 1. Conversely, the absorbance will be detected at extremely low surface coverage.

As illustrated in FIG. 7, transmission spectrum through a fiber coupled with a single microsphere will change from T₀(λ) to T₁(λ) when the sphere adsorbs a chemical which absorbs the light, or is immersed in an absorbing medium. The ratio T₁(π)/T₀(λ) represents transmission spectrum of the molecules adsorbed onto the sphere surface or the surrounding medium. The ratio is meaningful at wavelengths where T₀(λ)<1. At other wavelengths, absorbance by the immersing medium does not show in T₁(λ). The latter may appear to place a severe restriction, but there is a way to obtain a continuous absorption spectrum of the medium using microspheres with high sensitivity, as explained below.

The dips in T₀(λ) may be regarded as the photonic density of states of a microsphere. The density of states can be increased by attaching many similar spheres along a single fiber. In practice, it will be easy to have dense resonance lines as illustrated in FIG. 23. Increasing the density of states will enhance the sensitivity as well.

Typical dispersing elements (monochromaters) in spectrometers have a resolution of 1 nm. It is rare that a higher resolution is required for molecular spectroscopy. When a monochromator is used to read the transmission spectrum through the fiber, any peak associated with molecular absorption or emission will contain more than one lines in T₀(λ), and therefore T₁(λ)/T₀(λ) will give a continuous transmission spectrum of adsorbed molecules or the immersing medium.

In the range of wavelength (0.2≦λ/μm≦5.0) in which silica is transparent, many molecules have electronic and vibrational absorptions. These spectra often carry a signature of the molecules, thus allowing identification. FIG. 24 shows near-infrared (NIR) absorption spectra of dinitrotoluene (DNT), a non-explosive precursor TNT. Some of the absorption peaks are due to the overtone modes of aromatic and methyl C—H stretch.

Referring to FIGS. 25A-25D, for fluorescence and absorption spectrum measurement, microspheres with a common surface modification A may need to be attached to a given fiber. Another fiber may have microspheres with another surface modification B, etc. Fluorescence and absorption spectra of ligand A will change when it is complexed with a target chemical A′, but those of B will not change since A′ does not complex with B. The contrast will indicate the presence of A′.

Referring back to FIGS. 14 and 15, these methods can be used when instances of “resonant frequencies” are replaced with “transmission spectra.”

§ 4.4.2 Exemplary Methods, Apparatus and Compositions of Matter for Performing Operations Related to Fabricating Sensors

Recall from FIG. 5 that the system 500 uses a sensor 530. Recall from FIGS. 9, 11 and 26 that a sensor may be characterized as a single-sphere sensing head, a multiple-sphere sensing head, or a sensing box. In each case, as summarized in FIG. 6, the fabrication of a sensor head involves two basic operations—coupling the microsphere(s) and optical fiber(s), and attaching receptor(s) to a microsphere(s). Methods and apparatus that may be used to perform these operations, as well as the resulting sensors, are now described. Note that the methods, apparatus, and components used will often depend upon the ultimate application of the sensing head.

§ 4.4.2.1 Exemplary Materials for the Fiber and Microspheres

Inorganic glasses, such as silica, or an amorphous polymer, such as poly(methyl methacrylate) (“PMMA”), are suitable materials for the optical fiber. Other known materials for optical fiber may be used.

The microsphere(s) can be any transparent material, such as silica, saffire, BK7, polystyrene, PMMA, polycarbonate, poly(ethylene terephthalate), etc. Spheres of different diameters are commercially available (such as from PolySciences, Inc., of Warrington, Pa.).

The microsphere(s) and the fiber may be made of the same material, though this is not necessary. However, it is preferable to keep the refractive indices of the microsphere(s) and fiber close to each other to promote phase matching.

§ 4.4.2.2 Exemplary Methods for Coupling the Fiber and Microsphere(s)

In the following, the term “connection” will be used to generally refer to all (e.g., mechanical, optical, electro-magnetic, etc.) interactions between a microsphere and a fiber. The term “coupling” will refer to the evanescent connection of a microsphere and a fiber, while the term “bridge” will refer, without loss of generality, to the mechanical connection of a microsphere and a fiber. Some theory related to desirable connection characteristics is first introduced in § 4.4.2.2.1. Then the affects of symmetry, distance, and mechanical bridging are described in §§ 4.4.2.2.2 through 4.4.2.2.4 below. Finally, some exemplary methods and compositions of matter for attaching the fiber and microsphere(s) are described in § 4.4.2.2.5.

§ 4.4.2.2.1 Optical Coupling via Evanscent Fields

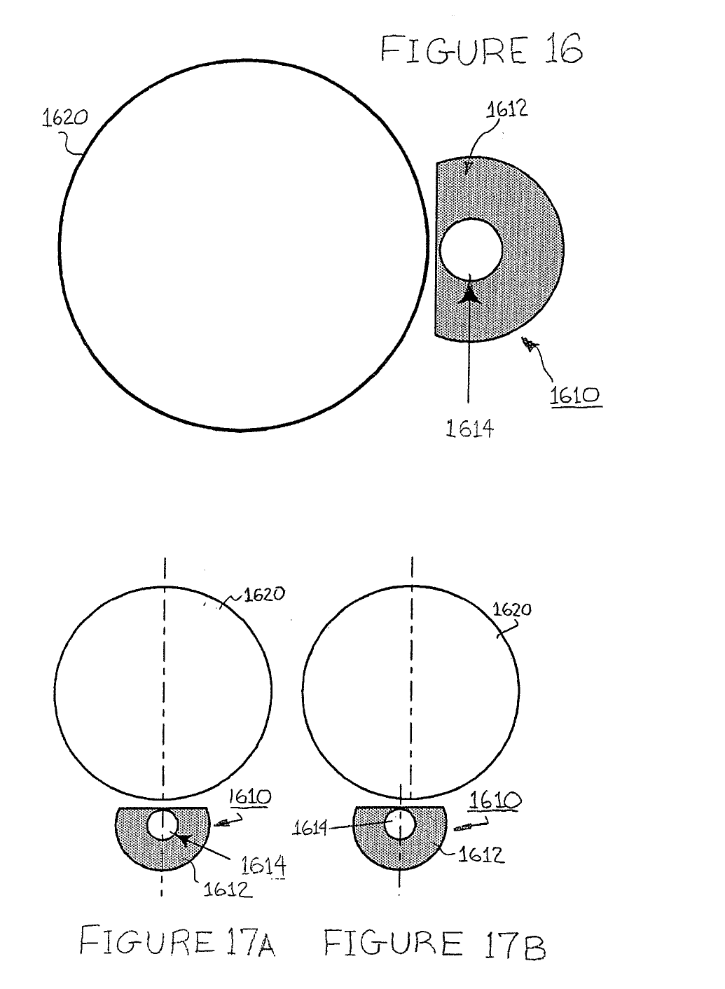

By overlapping the evanescent field that surrounds a microsphere, and typically extends for a characteristic length of about 0.1 μm from the surface, with the evanescent field from the core of an optical fiber, (optical) coupling can be achieved. (See, e.g., the article A. Serpenguzel, S. Arnold, G..Griffel, J. A. Lock, Efficient Coupling of Guided Waves to Microsphere Resonances Using an Opitcal Fiber, J. Opt. Soc. B, 14, 790 (1997).) A cross-sectional end view of a basic half-coupler 1600 is illustrated in FIG. 16. In the half-coupler 1600, light is directed through the optical fiber 1610 (into the page). The fiber cladding 1612 is eroded to expose the evanescent field just outside the core 1614. The eroded fiber 1610 is pressed against the microsphere 1620.

§ 4.4.2.2.2 Effects of Symmetry of a Microsphere-to-Fiber Connection

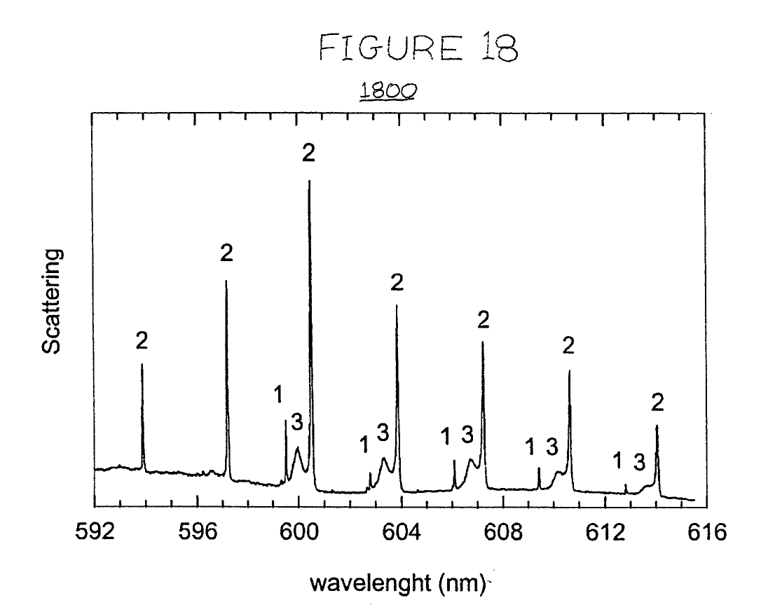

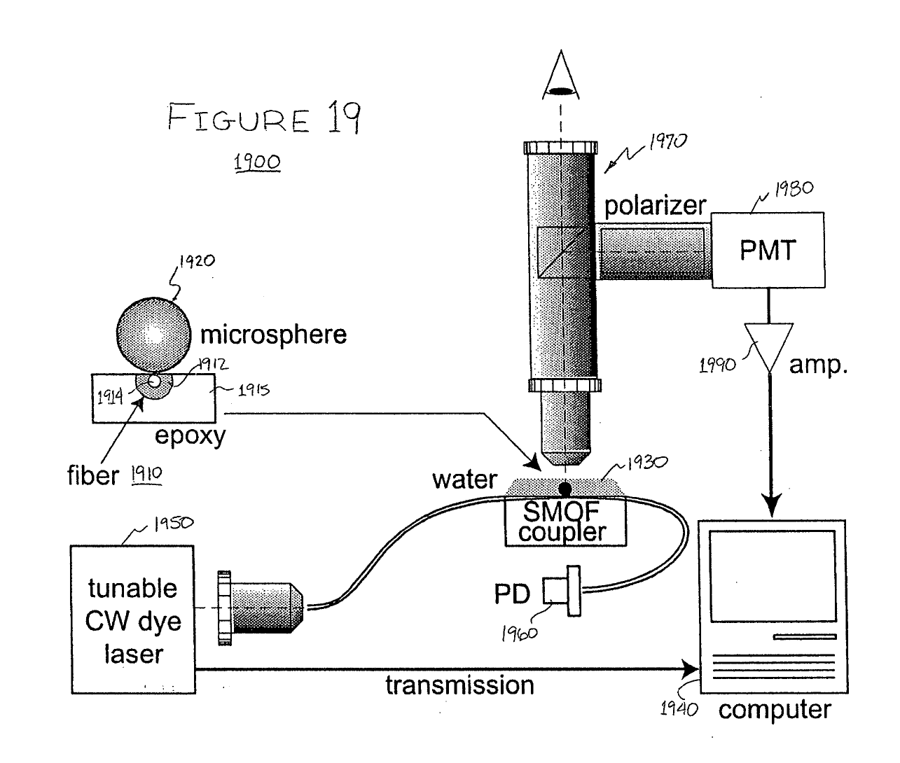

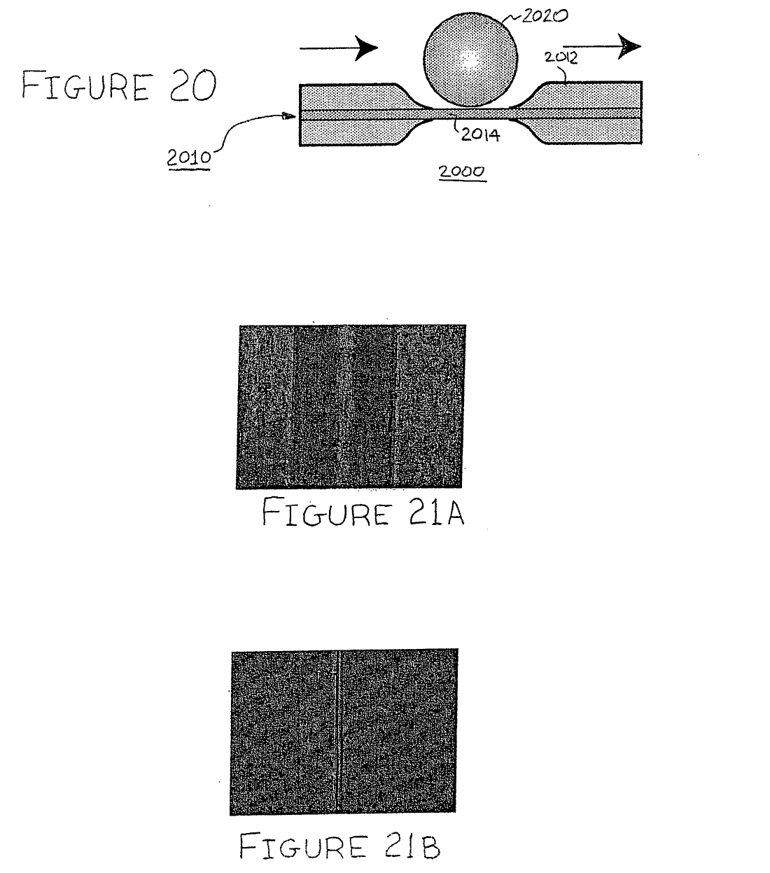

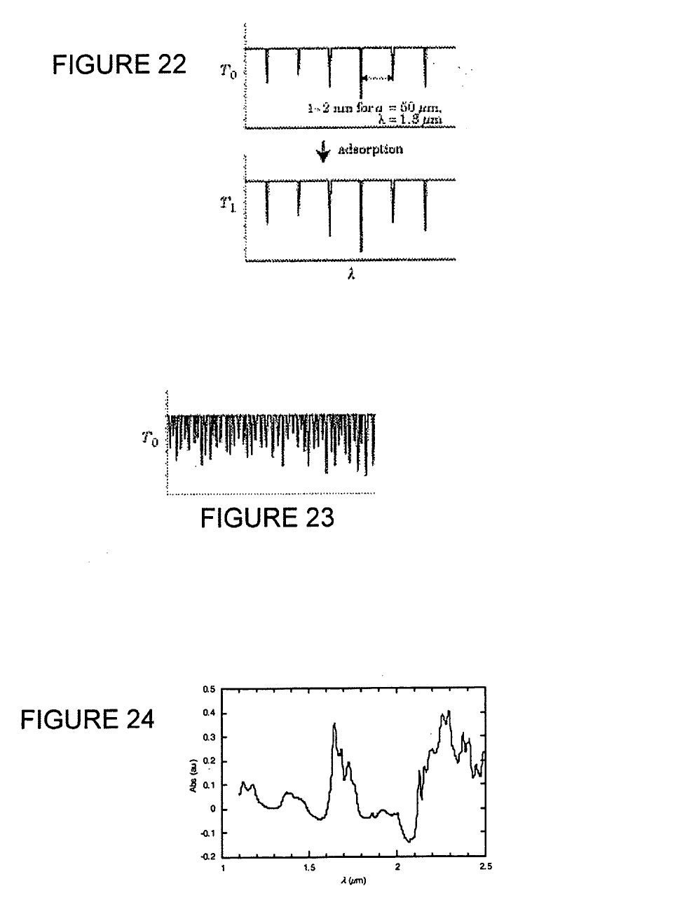

It is desirable to provide a symmetric connection between the eroded fiber 1610 and the microsphere 1620, such as shown in FIG. 17A. If the center of the microsphere 1620 is not located above the center of the fiber core 1614, such as illustrated in FIG. 17B, coupling may be substantially attenuated. This was observed in the resonance spectrum, shown in FIG. 18, of an experimental system illustrated in FIG. 19.

More specifically, in the experimental system 1900 of FIG. 19, a fiber 1910 was epoxied to a Lucite block 1915. The combination was sanded and polished to eliminate most of the cladding 1912 from one side of the fiber 1910. Light from a tunable dye laser 1950 was coupled into the fiber with a polystyrene microsphere 1920 having a radius 15 μm. The microsphere 1920 was immersed in water. In one experiment, no scattering (i.e., radiation leakage) was observed from the microsphere 1920 until the wavelength was tuned to resonance, although scratches on the polished surface caused a small amount of background scattering. As indicated on the detected spectrum 1800 of FIG. 18, three orders of resonance occurred, the narrowest of which was essentially the same as that of the dye laser resolution (e.g., 0.025 nm). Note that the nearly periodic repeating resonances of a given order are associated with the mode number. Since the measured spectrum is a convolution of the intrinsic resonance line and the laser line, the actual resonance width is considerably narrower than measured. Wave theory can be used to predict the position of all of the resonance in the spectrum 1800 using just one adjustable parameter “a”. Note, however, that near the beginning of the resonance spectrum 1800, the first-order modes are not present.

Such undesirable asymmetric contact may occur if the microsphere (a) is improperly positioned, and/or (b) moves (e.g., rolls) out of position. To secure the symmetric coupling between the evanescent fields of the microsphere and the fiber by ensuring symmetric contact such as that illustrated in FIG. 17A, a polymer microsphere may be attached, covalently, with the eroded fiber. Details of attachment techniques are given in 4.4.2.2.5.

§ 4.4.2.2.3 Effects of Separation Distance of a Microsphere-to-Fiber Connection

In addition to the desirability of symmetric coupling, the distance between the microsphere and fiber core will also affect performance. More specifically, if the microsphere and fiber core are too far apart, the coupling of their respective evanescent fields may be insufficient. If, on the other hand, the microsphere and fiber core are too close, the presences of the fiber's evanescent field may change the boundary condition of the microsphere, thereby undermining the inherently high quality factor (Q) of the resonance. However, the inventors have found that permitting the microsphere and fiber core to contact one another is acceptable in some applications. In any event, the distance can be adjusted by the length of methylene units in the diamine used for fiber-sphere coupling or by controlling etch time of the silica fiber, for instance.

### § 4.4.2.2.4 Effects of the Bridging of a Microsphere-to-Fiber Connection

Further, the bridge physically coupling the microsphere(s) and the fiber should be mechanically strong and durable. However, the coupling should minimize the perturbation to the resonating state of the photon(s) in the microsphere. Thus, for example, a bridge coupling each microsphere with the fiber should be small.

Note that in a multi-sphere arrangement, nearest neighbor spheres may interfere with one another, making the overall fiber transmission spectrum different from the product of the transmission spectra to be obtained for individual spheres. The minumum distance between the spheres should be selected to avoid interference.

### § 4.4.2.2.5 Exemplary Methods and Compositions of Matter for Attaching the Fiber and Microsphere(s)

FIG. 20 is a cross-sectional side view of a sensing head (section) 2000 including an attached microsphere 2020 and fiber 2010. To locate the microsphere 2020 symmetrically, with respect to the fiber core 2014, the fiber 2010 was eroded on all sides (referred to as “cylindrical erosion”). Such cylindrical erosion of the cladding 2012 can be effected by etching the fiber 2010 at a desired region or regions with a hydrofluoric acid solution or a base solution, thereby exposing the evanescent field of the fiber core 2014. In one exemplary fabrication method, the etching was terminated when the amplitude of a laser transmitting through the fiber showed a hint of decrease. As illustrated in FIGS. 21A and 21B, a silica fiber with cladding had an initial total diameter of ˜125 μm, before being eroded to a diameter of ˜6 μm. The final diameter can be controlled by changing the concentration of the acid or the base and the etching time.

Plastic fiber may be eroded by immersing it into a solvent that dissolves the cladding. For example, a PMMA fiber with a fluoropolymer cladding (available from Mitsubishi Rayon and Toray) can be eroded in a solution of hexafluoroisopropanol.

Other methods for exposing evanescent field of the core of the optical fiber will be apparent to those skilled in the art. Now, exemplary methods and compositions of matter for attaching a microsphere to a fiber are described. Generally though, the microspheres may be connected to the eroded fiber with techniques used by biochemists for attaching microspheres to microscope slides (See, e.g., F. J. Steemers, J. A. Ferguson, D. R. Walt, Screening Unlabeld DNA targets with Randomly Ordered Fiber Optic Gene Arrays, Natur. Biotech. 18, 91 (2000).), or by other silanization methods (See, e.g., The Colloid Chemistry of Silica, H. E. Bergna, ed. Adv. Chem. Ser. 234, Amer. Chem. Soc. (1994); E. P. Plueddemann, Silane Coupling Agents Kluwer (1990).).

In a first example, a siloxane network may be used to bridge a silica fiber and a silica microsphere. More specifically, a tiny amount (e.g., ˜Pico liter) of tetramethozysilane or dimethyldimethoxysilane may be applied (e.g., dropped) into a space between a microsphere and the fiber, followed by dehydration and baking in an oven. (See, e.g., E. P. Plueddemann, Silane Coupling Agents Kluwer (1990).) The resultant fiber-sphere pair is chemically identical to bare silica.

In a second example, amide and other bonds may be used to bridge a silica microsphere and a silica fiber. More specifically, surface silanols and other metal hydroxides on the microsphere and fiber can be converted to primary amines. Consequently, the two amines will be bonded by acid anhydride or dialdehyde. Silica surface has a high density of reactive silanols (˜0.05 Å⁻²), or can at least be modified to have silanols at high density by washing in hydrochloric acid and rinsing followed by heating. Amino silanation will be accomplished by reacting silanols with amino silanation agencies such as aminopropyl trimethoxysilane. The silanation methods have been widely used to make glass fiber compatible to a plastic matrix to prepare fiber-reinforced plastic. (See, e.g., the article E. P. Plueddemann, Silane Coupling Agents Kluwer (1990).) Bridging two amines with acid anhydride such as succinic anhydride or dialdehyde such as glutaraldehyde is widely used in biochemistry. (See, e.g., the article J. McCafferty, H. R. Hoogenboom, D. J. Chiswell Ed., Antibody Engineering, IRL Press (1996).)

After being converted into amines, the hydroxides on the surface of inorganic glass can be further converted to aldehydes or carboxylic acids by standard silanization procedures. (See, e.g., FIG. 27.)

Instead of amine modification, the silica surface can be modified with carboxylic acid (by aminopropyl modification followed by reaction with succinic anhydride) and bridge two acids with carbodiimide.

The two foregoing methods form similar functional groups on both the fiber and microsphere. The inventors believe that one of these functional groups can be modified with amine and the other of these functional groups can be modified with carboxyl, so that the contact points can convert to amide bonds.

Amide bond formation is advantageous in that (i) the bonds are formed only where the sphere and fiber are in contact, and (ii) the resultant microsphere-fiber complex retains reactive surface moieties for further biochemical and biological functionalization.

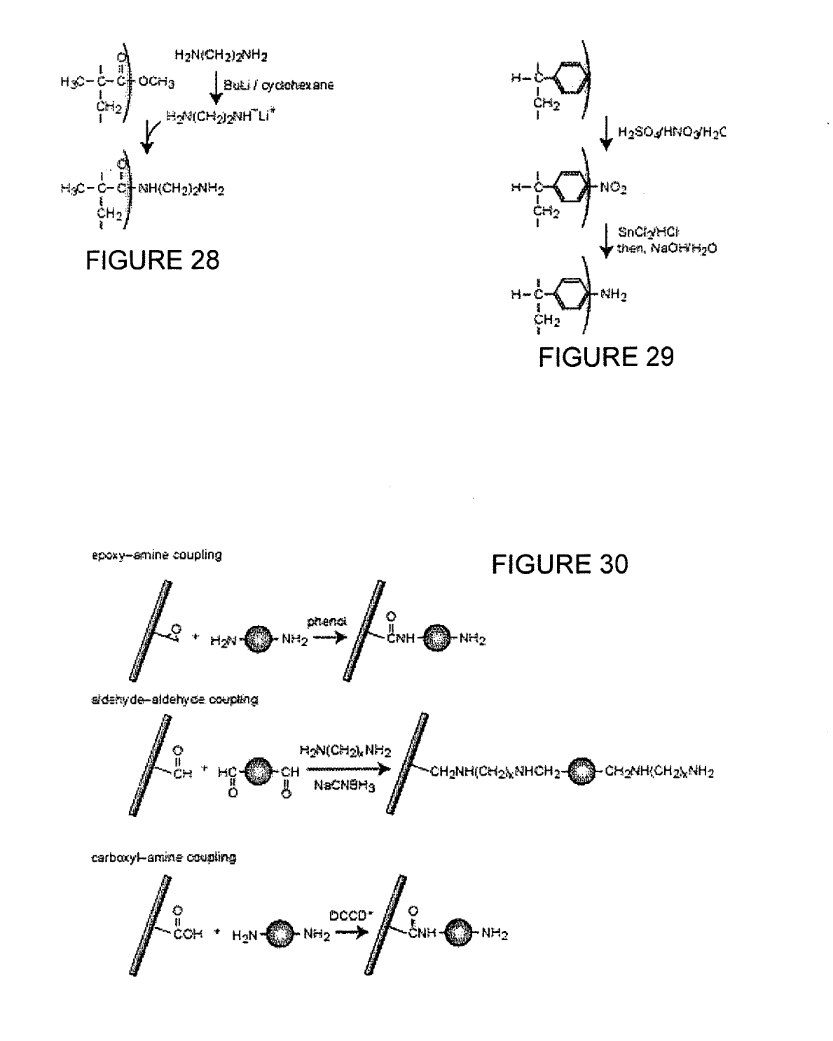

In a third example, a plastic fiber is connected with a plastic microsphere. PMMA spheres having a carboxylated surface are commercially available, in various diameters, from PolySciences Inc. of Warrington, Pa. However, the PMMA core of optical fiber does not have a carboxylated surface (not functionalized). Carboxylic acid may be attached to the optical fiber core by coating the eroded fiber with a copolymer of methyl methacrylate and acrylic acid in solution, followed by annealing. Thereafter, bridging the two carboxylic groups can be done in the same manner as described above for bridging silica. FIGS. 28 and 29 illustrate modifications of PMMA and PS surfaces, respectively. In this way, the microsphere surface can be made available for further reactions. Core-exposed fiber may be made reactive in the same way. Then, the fiber and microsphere(s) can react, as shown in FIG. 30 for example, to form a structure resembling beans on a string. The scheme shown in FIG. 30 was used to bridge silica fiber and borosilicate microspheres having a diameter of approximately 70 μm.

A tiny amount of silanization agent and a bridging agent may be provided (e.g., dropped), for example with a Pico liter jet (See, e.g., the article S. Arnold, L. M. Folan, A Fluorescence Spectrometer for a Single Electrodynamically Levitated Microparticle, Rev. Sci. Inst. 57, 2250 (1986).) onto the microsphere-fiber core contact.

Referring back to FIG. 9, a slightly spheroidal fused silica bead can be formed at the end of silica fibers by melting it with a microtorch. (See, e.g., the article V. B. Braginsky, M. L. Gorodetsky, V. S. Ilchenko, Quality-Factor and Nonlinear Properties of Optical Whispering-Galley Modes, Phys. Lett. A, 137, 393 (1989).) In one experiment, a quality factor (Q) of 3×10⁷ was maintained for such a sensing head 900.

Assuming conversion of about 25% of the surface silanols, the expected surface density of attached moieties is about 1 nm⁻². For spectroscopic measurement, the surface modification, in which porous silica beads (controlled pore glass) with a large surface area, may be performed in the same way. The surface-modified silica beads may be immersed in a solvent that is nearly isorefractive with silica and does not have hydrogen atoms. Carbon tetrachloride and 100% deuterated chloroform are examples of such solvents. Although the wavenumber range may be limited to the one between 4,000 and 2,100 cm⁻¹, the range is home to all hydrogen stretch motions and C≡N stretch motion. For instance, conversion of amine to amide in FIG. 27 can be identified by a change in the N—H peaks and a change in the C—H peaks.

### § 4.4.2.3 Providing Receptors on Microsphere(s)

Recall that the surface of a microsphere used to detect a substance will be modified with a receptor to interact with that substance (a specific ligand). Naturally, the receptor used will depend upon the particular application for which the sensor head is to be used. Various exemplary microsphere-receptor combinations are described below.

To adsorb target chemicals and/or to avoid adsorption of any other chemicals, the surface of the microspheres is modified. For tip-molten spheres, surface silanol may be used as reactive sites to attach receptors. For covalently bonded spheres, surface amines may be ready to react to attach receptors. Examples of surface modification are shown below. Microspheres with other modifications are possible.

§ 4.4.2.3.1 Providing Receptors on Microsphere(s) for Detecting TNT

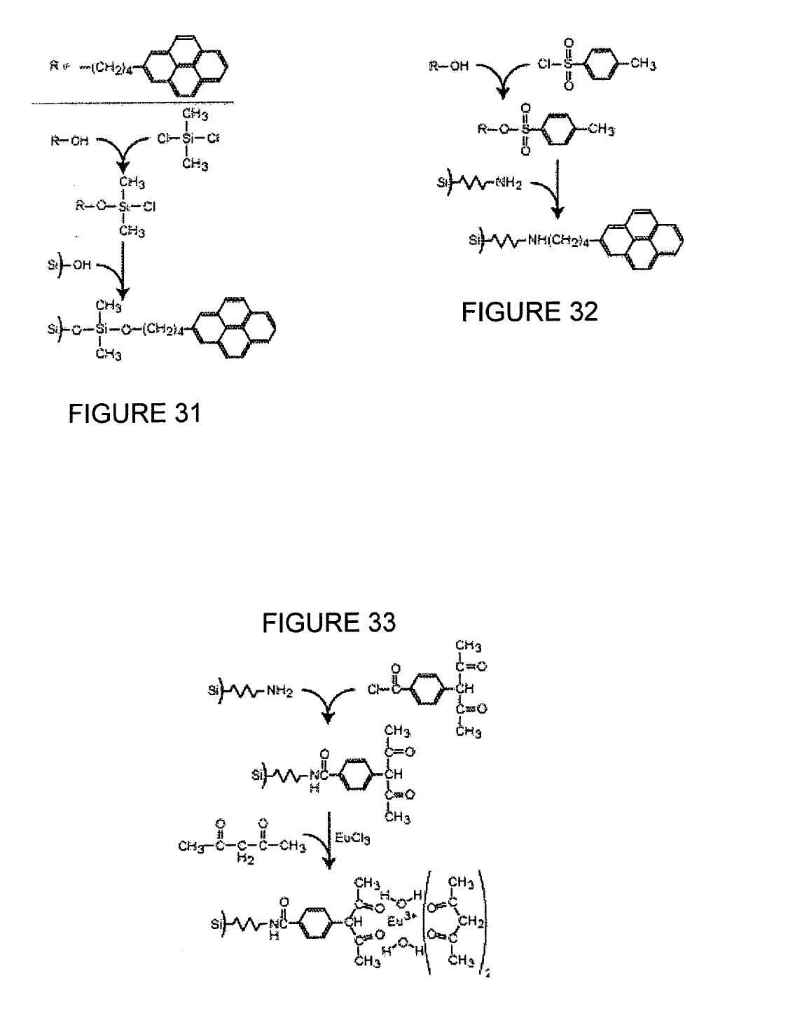

Polyaromatic compounds, especially pyrenes, are known to form a complex with TNT. As shown in FIG. 31, to attach pyrenes onto silanol, pyrene butanol (commercially available) may be reacted with dichlorodimethlsilane. Then, the product may be reacted with silanol.

As shown in FIG. 18, to attach pyrenes to amine-modified silica, pyrene butanol may be reacted with p-toluenesulfonyl chloride to be converted to pyrene butyl tosylate. The produce may then be reacted with surface amine.

To minimize false signals by non-target chemicals that may be adsorbed onto pyrene, microspheres may be modified with anthracene, phenanthrene, and naphthalene. A compound almost similar to TNT should exhibit its own adsorption onto each of these surface moieties and cause a unique fluorescence shift or quench.

§ 4.4.2.3.2 Providing Receptors on Microsphere(s) for Detecting Soman

Hydrolysis product of Soman, pinacolyl methylphosphate (PMP), is known to coordinate with Eu³⁺ chelate. As shown in FIG. 19, to attach europium chelate onto a silica surface, beta diketone may-be synthesized, which may be reacted with surface amine. In FIG. 19, water molecules are surrounding Eu³⁺, but will be replaced with PMP if it is present. The fluorescence spectrum change will be obvious at 610 nm. Other lanthanide chelates may be prepared and used to distinguish false signals.

To prepare non-stick surface, fluorocarbon compound may be attached to the surface. For instance, heptafluoro butyryl chloride can react with silanol or amine to coat the surface with C₃F₇— moieties.

§ 4.4.3 Refinements and Alternatives

The shift in the resonance wavelength and the change in the absorption and emission spectra may be measured as a function of the vapor pressure or the concentration of a target substance to establish the adsorption isotherm. There may be hysteresis.

Isotherm may be studied using a gas-tight box. For example, TNT may be introduced into the box by evaporation. The vapor pressure may be adjusted by temperature control. The concentration of PMP in water can easily be specified. This will permit a comparison of sensitivities of various surfaces for the target as well as other molecules that have a similar structure. They include organo phosphate pesticides for the Soman derivative.

Some surface moieties may turn out to be irreversible for the target. Reversibility is important if the sensors are to be re-used, but is not important if the sensors are to be one-use or disposable. If reversibility is desired, a surface moiety that allows reversible adsorption with a high sensitivity and specificity should be chosen.

The surface density of adsorption sites may be increased by a factor of ten or more by using polymer brushes or gels grown from the sphere surface. Ligands may be covalently bonded through many points on the brushes or gels. For instance, chlorosilane-containing initiator for surface polymerization is known.

More importantly, however, selective modification of the microsphere surface around the path of orbiting photons will increase the sensitivity by a factor of 10 or more. Resonance modes, especially with those of a high orbital angular momentum quantum number 1, are sensitive to the changes on the equator of the sphere and insensitive to the rest. See, e.g., U.S. patent application Ser. No. 10/690,979, titled “ENHANCING THE SENSITIVITY OF A MICROSPHERE SENSOR,” filed on Oct. 22, 2003 and lising Stephen Arnold, Iwao Teraoka and Frank Vollmer as the inventors. That patent application is incorporated herein by reference.

Molecular imprinting technology may be used to enhance the specificity for the target chemical. The coating may have a thickness of 1 μm or less to minimize the response time.

§ 4.5 Conclusions

It is clear from the foregoing that the present invention provides a small, highly-sensitive with a high quality factor (Q), sensing head and system for detecting and/or measuring various chemical substances, such as explosives or poison gases. The resolution and dynamic range of the resonance far exceeds those of existing detection schemes. Indeed, the high quality factor (Q) detection enables unprecedented opportunities for microscale sensing. Common-mode noise can be determined and removed by using a multiple-sphere sensing head.

What is claimed is:

1. A method for determining the presence or concentration of a substance in a medium, the method comprising:
a) providing a sensor in the medium, wherein the sensor includes at least one optical carrier and a microsphere having a surface including receptors for the substance, each of the at least one optical carrier being coupled with the microsphere;
b) applying a light source to one of the at least one optical carriers of the sensor;
c) detecting a transmission spectra of light from one of the at least one optical carriers of the sensor; and
d) determining a presence or concentration of the substance based on a change in the transmission spectra the detected light.

2. The method of claim 1 further comprising:
determining a change in the transmission spectra of the light due to a factor other than adsorption of the substance onto the surface of the microsphere,
wherein the act of determining a presence or concentration of the substance based on a property of the detected light, wherein the property is based on a change in the transmission spectra of the light, compensates for the determined change in the transmission spectra of the light due to a factor other than adsorption of the substance onto the surface of the microsphere.

3. The method of claim 2 wherein the sensor includes a second microsphere coupled with each of the at least one optical carrier,
wherein the second microsphere has a surface that is free of receptors for the substance, and
wherein the act of determining a change in the transmission spectra of the light due to a factor other than adsorption of the substance on the surface of the microsphere is based on a change in the transmission spectra of the light due to the second microsphere.

4. A system for determining the presence or concentration of a substance in a medium, the system comprising:
a) a sensor, for immersion in the medium, the sensor including
i) at least one optical carrier, and
ii) a microsphere having a surface including receptors for the substance, each of the at least one optical carrier being coupled with the microsphere;
b) a light source for applying light to one of the at least one optical carriers of the sensor;
c) a detector for detecting light from one of the at least one optical carriers of the sensor; and
d) means for determining a presence or concentration of the substance using a shift in the transmission spectra of the detected light.

5. The system of claim 4 wherein the sensor further includes
iii) a second microsphere coupled with each of the at least one optical carrier, wherein the second microsphere has a surface that is free of receptors for the substance.

6. For use in a system including a light source, and a light detector, for determining the presence or concentration of an explosive substance in a medium, a sensor comprising:
a) at least one optical fiber;
b) at least one microsphere, the at least one microsphere
i) being coupled with the optical fiber, and
ii) having a surface including receptors for the substance, wherein the receptors include polyaromatic compounds.

7. The sensor of claim 6 wherein the polyaromatic compounds are pyrenes.

8. The sensor of claim 6 wherein the explosive substance is TNT.

9. For use in a system including a light source, and a light detector, for determining the presence or concentration of a poison gas in a medium, a sensor comprising:
a) at least one optical fiber;
b) at least one microsphere, the at least one microsphere
i) being coupled with the optical fiber,
ii) having a surface including receptors for the substance, wherein the receptors include EU³⁺ chelate.

10. The sensor of claim 6 wherein the poison gas is Soman.

11. A method for fabricating a sensor for determining the presence or concentration of an explosive substance in a medium, the method comprising:
a) bridging at least one microsphere and an at least one optical core; and
b) functionalizing a surface of the microsphere with polyaromatic compound receptors.

12. The method of claim 11, wherein the polyaromatic compound receptors include pyrenes.

13. The method of claim 12, wherein the act of functionalizing the microsphere surface with pyrene receptors includes:
i) reacting pyrene butanol with dichlorodimethlsilane to generate a product, and
ii) reacting the product with a silanol on the surface of the microsphere.

14. The method of claim 13 wherein the explosive substance is TNT.

15. A method for fabricating a sensor for determining the presence or concentration of a poison gas in a medium, the method comprising:
a) bridging at least one microsphere and an at least one optical core; and
b) functionalizing a surface of the microsphere with EU³⁺ chelate receptors.

16. The method of claim 15, wherein the act of functionalizing the microsphere surface with EU³⁺ chelate receptors includes reacting diketon with an amine on the surface of the microsphere.

17. The method of claim 15 wherein the poison gas is Soman.
